(19) United States
(12) Patent Application Publication
(10) Pub. No.: US 2025/0276910 A1
(43) Pub. Date: Sep. 4, 2025

(54) FUNCTIONALIZED EXFOLIATED NANOCLAY

(71) Applicants: Kaneka Americas Holding, Inc., Pasadena, TX (US); Texas A&M University, College Station, TX (US)

(72) Inventors: Hung-Jue Sue, College Station, TX (US); Joseph Baker, College Station, TX (US); Fangqing Xia, College Station, TX (US); Cong Liu, College Station, TX (US)

(21) Appl. No.: 19/199,138

(22) Filed: May 5, 2025

Related U.S. Application Data
(63) Continuation of application No. 18/775,138, filed on Jul. 17, 2024, now abandoned.
Application No. 18/775,138 is a continuation of application No. 18/200,832, filed on May 23, 2023, now abandoned.
Application No. 18/200,832 is a continuation of application No. 16/701,542, filed on Dec. 3, 2019, now abandoned.
(60) Provisional application No. 62/774,549, filed on Dec. 3, 2018.

(51) Int. Cl. C01G 25/00; C08K 9/04

(52) U.S. Cl. CPC C01G 25/00; C08K 9/04; C01P 2004/24; C01P 2004/64

(57) ABSTRACT

A method of forming a composition having exfoliated nanoplatelets functionalized with covalently bound surface-modifiers, includes exfoliating a layered nanoclay is exfoliated with a surfactant. The method also includes reacting the exfoliated layered nanoclay with a surface modifier comprising one or more of an epoxide, a silane, or an isocyanate.

### PRIORITY CLAIM

This application is a continuation of U.S. patent application Ser. No. 18/775,138 filed Jul. 17, 2024, which is a continuation of U.S. patent application Ser. No. 18/200,832 filed May 23, 2023, which is a continuation of U.S. patent application Ser. No. 16/701,542 filed Dec. 3, 2019, which claims the priority of U.S. Provisional Application No. 62/774,549, filed Dec. 3, 2018. All of the aforementioned applications are hereby incorporated by reference in their entireties.

### BACKGROUND

ZrP is sometimes converted to ammonium salt with aqueous NH4OH, followed by reaction with styrene oxide. Sometimes, ZrP is reacted with 1-dodecene oxide, with isocyanates, or with a silane after a surfactant used for exfoliation was removed with acid.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of a method, in accordance with one or more embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

This disclosure describes functionalized, exfoliated nanoplatelets that can be dispersed in solvents and polymers. The described nanoplatelets can be added to thermosets and thermoplastics to improve properties such as barrier to oxygen and water. In some embodiments, the described nanoplatelets can be added to thermosets and thermoplastics to improve mechanical properties.

The described nanoplatelets are prepared using a two-step process. The first step comprises separating individual nanoplatelets from a particle containing numerous stacked nanoplatelets. In some embodiments, individual nanoplatelets are exfoliated from a particle containing numerous stacked nanoplatelets. In some embodiments, individual nanoplatelets are separated from a particle containing numerous stacked nanoplatelets using a surfactant that is bound to the surface by ionic interactions with acid groups on the surface of the nanoplatelet. The second step comprises replacing the surfactant with a covalently bound moiety that prevents aggregation of the nanoplatelets in solvent and polymers.

The discussed two-step process converts particles with low aspect ratios (<10) to nanoplatelets with high aspect ratios (>50). Exfoliating the starting particles with high efficiency helps to avoid yield-loss associated with non-exfoliated or partially exfoliated stacks of nanoplatelets, which can sometimes limit the ability of the nanoplatelets to improve properties such as barrier to oxygen and water and/or mechanical properties

Although there are various means to demonstrate the extent of exfoliation, one simple method is to test whether a suspension is capable of rotating polarized light by placing a sample between a pair of polarizing films placed at 90 degrees. Samples with a high amount of exfoliated nanoplatelets will appear bright with regions of different colors. This is caused by local alignment of the nanoplatelets that causes refraction of light. This behavior is sometimes referred to as liquid crystallinity. Suspensions of nanoclays that contain an insufficient concentration of exfoliated nanoplatelets appear dark in cross-polarizers. The observance of the visible refraction of light is dependent on a number of factors, but two important factors are the aspect ratio of the particles (where higher is better) and the concentration.

The discussed method is usable for preparing exfoliated nanoplatelets that are capable of exhibiting liquid crystalline behavior, as well as compositions comprising the exfoliated nanoplatelets that exhibit liquid crystalline behavior. Compositions that contain nanoplatelets at a concentration too low to exhibit liquid crystalline behavior, but do so at higher concentrations, are also described.

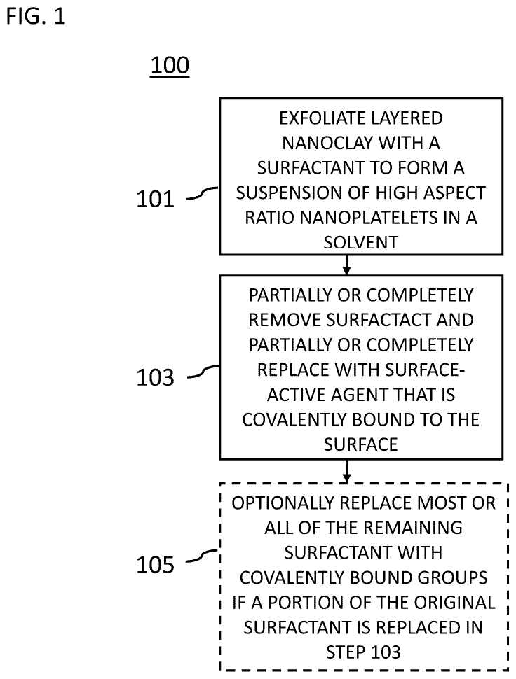

FIG. 1 is a flowchart of a method 100, in accordance with one or more embodiments. In some embodiments, method 100 is a general procedure for preparing the discussed materials comprises two or three steps.

In a first step 101, a layered nanoclay is exfoliated with a surfactant to form a suspension of high aspect ratio nanoplatelets in a solvent. In some embodiments, this step is performed using techniques described in H.-J. Sue, J. Mater. Chem. A., 2015, 3, 2669-2676, which is incorporated herein by reference. In some embodiments, a synthetic nanoclay (alpha-zirconium phosphate or ZrP) is exposed to a surfactant in a polar solvent. The use of high-shear mixing may be advantageous. The product of this step is a stable suspension of nanoplatelets (coated on both sides with the surfactant) in a polar solvent. The nanoplatelets in layered nanoclays are bound together by hydrogen bonds formed between hydroxyl groups (such as —P(O)OH or —SiOH). The surfactant forms an ionic or covalent bond with the surface hydroxyl groups and prevents aggregation of the isolated nanoplatelets.

In some embodiments, the layered nanoclay comprises one or more of montmorillonite, boehmite, magadiite, cloisite, silicate-based nanoclays, or other suitable nanoclays, or synthetic nanoclays such as alpha zirconium phosphate (ZrP), or other suitable synthetic nanoclays.

In some embodiments, the surfactant comprises one of more of a polyol that has amine group(s) at one end, ammonium salts such as tetrabutylammonium hydroxide, or other suitable substance that reduces the surface tension of a fluid, liquid or medium in which the substance is dissolved. In some embodiments, one or more of the surfactants are recyclable to be used for exfoliation.

In some embodiments, the solvent comprises one or more of water, methanol, acetone, 2-butanone, tetrahydrofuran, and glymes (such as 1,2-dimethoxyethane), or other suitable substance, fluid, liquid or medium.

In a second step 103, the surfactant is partially or completely removed and replaced with a surface-active agent that is covalently bound to the surface. This is performed by reacting the product from the first step 101 with a ‘hydroxyl-reactive moiety’ such as mono-or polyfunctional epoxides, isocyanates, carboxylic acid derivatives, or alkoxysilanes. In some embodiments, a portion of the surfactant is replaced with one hydroxyl-reactive moiety, followed by replacement of all or a portion of the remaining surfactant with a second hydroxyl-reactive moiety.

In some embodiments, an optional third step 105 is used when a mixture of covalently bound groups is desired. In this case, during the second step 103 only a portion of the original surfactant is replaced. The third step 105 comprises replacing most or all of the remaining surfactant with covalently bound groups.

In some embodiments, the hydroxyl-reactive moiety comprises one or more suitable epoxides that include 1,2-epoxydodecane, 1-butylglycidyl ether, cyclohexene oxide, glycidyl methacrylate, epoxidized soybean oil, bisphenol A diglycidyl ether, bisphenol F diglycidyl ether, dipropylene glycol diglycidyl ether, other suitable epoxide, or one or more suitable isocyanates that include isocyanatoethylmethacrylate, phenyl isocyanate, dodecylisocyanate, methylene diisocyanate. Suitable alkoxysilanes include butyltrimethoxysilane, dodecyltrimethoxysilane, other suitable isocyanate, or other suitable hydroxyl-reactive moiety.

Some examples of the various embodiments are discussed below.

### EXAMPLES

### Example 1: Preparation of α-Zirconium Phosphate (ZrP) with Surface-Bound 1-hydroxy-1-cyclohexyl Groups

Step 1 (exfoliation): ZrP was prepared according to a published procedure (H.-J. Sue, J. Mater. Chem. A., 2015, 3, 2669-2676). The exfoliation of ZrP was carried out using Jeffamine M1000 (a copolymer of ethylene oxide and propylene oxide with an amine group at one end only). For dispersion, 6 g of ZrP mixed with 210 ml of acetone in a 500 ml round bottom flask and sonicated for 30 minutes. A Jeffamine M1000 solution in acetone (0.6 g/ml) was added (33 mL) dropwise to the stirring ZrP mixture. This dispersion was allowed to stir for 12 h. The dispersion was sonicated for 60 min followed by centrifugation at 10,000 rpm for 30 min. The sediment was removed leaving a clear suspension containing exfoliated ZrP-M1000 and excess Jeffamine M1000. The excess Jeffamine M1000 was removed via dialysis with acetone. IR (cm−1): 2866 broad (C—H). TGA (O2) mass loss 190-420° C., 51.33 wt %.

Step 2 (replacement of surfactant with covalently-bound moiety): In a 20 mL vial, ZrP-M1000 exfoliated platelets (100 nm) were dispersed in xylene (ZrP concentration 30 mg/ml). The solution was heated to 110° C. and 40 equivalents (to ZrP) of cyclohexene oxide were added. The reaction mixture was stirred for 60 h before cooling. Samples were purified via recrystallization with toluene/hexanes.

DLS (Z avg.) diluted in THF 12 um, IR (cm−1) 2933 (C—H), 2861 (C—H). TGA (O2) mass loss from 190-420° C., 28.47 wt %. Colorful liquid crystals were observed under cross polarized light after reaction in xylene.

One sample was hydrolyzed over 2 days by stirring in a KOH isopropanol mixture. The solution was acidified to pH 2.5 with a 0.1 M HCl solution and extracted with chloroform. The chloroform was analyzed by chemical ionization (CI) MS negative mode. The masses for the epoxides plus phosphate were found, evidence of the new covalent bond to the material.

### Example 2: Preparation of α-Zirconium Phosphate (ZrP) with Surface-Bound 1-propyl-2-hydroxy-3-phenoxy Groups

The 2-step procedure of Example 1 was repeated using 1,2-epoxy-3-phenoxypropane. Colorful liquid crystals were observed in the product suspension under cross polarized light.

DLS (Z avg.) diluted in THF 240 nm, IR (cm−1) 3061 (C—H), 2944 (C—H), 2872(C—H). TGA (O2) mass loss from 190-420° C., 34.57 wt %.

### Example 3: Preparation of Zirconium Phosphate (ZrP) with Surface-Bound 1,2-epoxy-3-phenoxypropane and 1-dodecyl/tetradecyl-2-hydroxy Groups

Step 1 (exfoliation): See Example 1, Step 1.

Step 2 (epoxide addition): In a 20 mL vial, ZrP-M1000 exfoliated platelets (100 nm) were dispersed in xylene (ZrP concentration 30 mg/ml). The solution was heated to 50° C. and 2 equivalents (to ZrP) of 1,2-epoxy-3-phenoxypropane were added dropwise. The reaction mixture was stirred for 15 h at 50° C. before cooling. Samples were purified via dialysis with acetone.

Step 3 (replacement of surfactant with second covalently-bound group): In a 20 mL vial, ZrPM1000-1,2-epoxy-3-phenoxypropane exfoliated platelets (100 nm) were dispersed in xylene (ZrP concentration 30 mg/ml). The solution was heated to 110° C. and 20 equivalents (to ZrP) of dodecyl/tetradecyl glycidyl ether were added dropwise. The reaction mixture was stirred for 15 h before cooling. Samples were purified via dialysis with acetone. DLS (Z avg.) diluted in THF 101 nm. TGA (O2) mass loss from 190-420° C., 45.02 wt %. Lyotropic behavior was seen under cross-polarized light in methyl methacrylate at a 3 wt % concentration.

### Example 4: Preparation of Zirconium Phosphate (ZrP) with Surface-Bound glycidyl methacrylate and dodecyl/tetradecyl glycidyl ether

Similar procedures were repeated to Example 1, except in Step 2, glycidyl methacrylate was used instead of 1,2-epoxy-3-phenoxypropane.

DLS (Z avg.) diluted in THF 102 nm. IR (cm−1) (C—H) 2922 (C—H) 2882 (C═O) 1716 (C═C) 1637. TGA (O2) mass loss from 190-420° C., 42.77 wt %. Lyotropic behavior was seen under cross-polarized light in methyl methacrylate from 3-15 wt %. AFM was used to confirm exfoliation and measure the platelet size. Single platelets have an average diameter of 102.8 nm and a height of 2.97 nm.

### Example 5: Similar Procedures were Repeated to Example 2, Except in Step 3, Cyclohexene Oxide was used instead of dodecyl/tetradecyl glycidyl ether

DLS (Z avg.) diluted in THF 109 nm. IR (cm−1) (C—H) 2930 (C—H) 2863 (C═O) 1713 (C═C) 1639. TGA (O2) mass loss from 190-420° C., 36.86 wt %. Lyotropic behavior was seen under cross-polarized light in methyl methacrylate from 3-10 wt %. AFM was used to confirm exfoliation and measure the platelet size. Single platelets have an average diameter of 101 nm and a height of 2.0 nm.

Example 6: Preparation of Nanocomposites (ZrP-Glycidyl Methacrylate-Cyclohexene Oxide 3.1 wt % in PMMA)

The modified ZrP was dispersed in THF at a concentration of 7.3 mg/mL. Methyl methacrylate was added (0.500 g) to a 20 mL glass vial with 0.0125 g of AIBN, then 2.23 mL of the ZrP/THE solution was added to the mixture. The solution was sonicated for 5 minutes at room temperature. The THF was removed with a rotovapor and methyl methacylate was added back to 0.600 g. The solution was again sonicated before placed in an oven set to 60 C for 12 h. After the 12 h, the composite was dried at 60 C in a vacuum oven. The resulting nanocomposite was transparent and analyzed by TGA, TEM, XRD, and cross-polarized light. The 3.1 wt % was from the mass remaining at 900 C from TGA. Under cross-polarized light there is no birefringence. TEM shows complete exfoliation and random dispersion of the platelets. XRD shows no peaks at low angles.

ZrP-glycidyl methacrylate-cyclohexene oxide 9.8 wt % in PMMA.

The modified ZrP was dispersed in THF at a concentration of 7.3 mg/mL. Methyl methacrylate was added (0.600 g) to a 20 mL glass vial with 0.015 g of AIBN, then 6.2 mL of the ZrP/THF solution was added to the mixture. The solution was sonicated for 5 minutes at room temperature. The THF was removed with a rotovapor and methylmethacylate was added back to 0.600 g. The solution was again sonicated before placed in an oven set to 60 C for 12 h. After the 12 h, the composite was dried at 60 C in a vacuum oven. The resulting nanocomposite was transparent and analyzed by TGA, TEM, XRD, and cross-polarized light. The 9.8 wt % was from the mass remaining at 900 C from TGA. Under cross-polarized light the sample edges appear very colorful and the center has some birefringence but not as intense as the edge. TEM shows some alignment of the platelets and a d-spacing of 3 to 3.5 nm. XRD shows no intense intercalation peaks, but a shoulder at low angles from 2-4 degrees implying that the spacing is random.

The described compositions comprise nanoplatelets that are sufficiently exfoliated such that they ‘self-align’ under stress. In some embodiments, the nanoplatelets are incorporated into a coating formulation which results in alignment of the nanoplatelets parallel to the surface of the substrate. In the case of ZrP in an epoxy coating on steel or aluminum, the nanoplatelets greatly reduce the rate of oxygen and water diffusion through the coating, resulting in much improved corrosion protection.

In some embodiments, the described nanoplatelets are capable of being added to polymers without significant degradation of the polymer properties, which is helpful for various commercial applications. For example, the nanoplatelets used in the epoxy coating described above contain significant amounts of surfactant (polyols with 1000 g/mol molecular weight) that reduces the glass transition temperature of the cured coating. In some embodiments, the described compositions have the surfactant removed and replaced by much smaller, covalently bound organic groups. In some embodiments, the thickness of the ZrP platelets completely modified with epoxides are only 1.5-3.5 nm thick vs the 10 nm thickness of the ZrP with M1000.

In some embodiments, the surface-functionalization of ZrP is done directly from an exfoliated state with the surfactant still attached to the platelets, which is different compared to the surface-functionalization in conventional methods. Some other methods in which exfoliation is performed after covalent surface modifications have been done so through surfactant removal by acidification. The removal of the surfactant by an acidification process produces an amorphous sometimes called pellicular ZrP which, by nature, results in crystalline platelets that have not been shown to have the excellent properties the discussed composites are capable of having. Other compositions prepared without exfoliated platelets include substantial amounts of stacked nanoplatelets that have relatively high aspect ratios. Although suspensions of high aspect-ratio nanoplatelets in solvents can be lyotropic, meaning that the nanoplatelets “self-align,” this occurs when the concentration of nanoplatelets are above a critical concentration. Lyotropic suspensions refract light, which is visible as bright regions of color between polarizers. But, compositions formed by some conventional methods do not show lyotropic behavior, which means that the nanoplatelets are poorly exfoliated. This indicates that compositions formed by conventional methods are less useful as additives for polymers compared to the compositions formed by the described embodiments.

The compositions formed by the described embodiments, or nanoplatelets formed by the described embodiments, are useful as additives for coatings to improve scratch and corrosion resistance. For food packaging, the described nanoplatelets will reduce oxygen diffusion rates, and therefore allow inexpensive polyethylene films to compete with more expensive films such as Saran and EVOH.

In some embodiments, it is possible to improve the coating resistance of coatings by adding other fillers. Nanoplatelets aligned parallel to the surface work more efficiently in terms of added amounts. For corrosion resistance, macroscopic, high aspect ratio fillers such as mica are added to coatings. Mica fillers have much larger dimensions than ZrP (100-1000 times the length of each axis). This causes mica-filled coatings to be rough and to be relatively thick.

For food packaging, Saran and EVOH have good barrier to oxygen, and currently share the market for food packaging for items such as meat. Both films are substantially more expensive than polyethylene film. In addition, neither polymer can be recycled.

The described embodiments allow for the preparation of well-exfoliated nanoplatelets without surfactant, which has not been achieved before, and opens up many possibilities for improved polymer properties.

The preparation of exfoliated surfactant-free ZrP has been demonstrated as being capable of producing a material that can be put into a polymethylmethracylate polymer while maintaining exfoliation after the process. Some resulting composites after syntheses have shown alignment of the platelets and maintained the lyotropic behavior seen in solvent form. According to various examples, usage of this material with polymers has been demonstrated to enhance material properties. The discussed example embodiments are capable of being scaled up to make commercial quantities of the described nanoplatelets and/or compositions. In some embodiments, the described nanoplatelets make it possible to achieve different or additional functionalities on the ZrP surface and/or achieve different or additional material property enhancements of the nanocomposites.

An aspect of this description is related to a composition comprising exfoliated nanoplatelets functionalized with covalently bound surface-modifiers. In some embodiments, the covalently bound surface-modifiers are derived from a reaction of a primary or a secondary epoxide. In some embodiments, the nanoplatelets are derived from a natural nanoclay. In some embodiments, the nanoplatelets are derived from a synthetic nanoclay.

Another aspect of this description is related to a composition comprising exfoliated nanoplatelets functionalized with covalently bound surface-modifiers. The composition also comprises an organic medium comprising one or more of a polymer or a solvent. The composition is in a lyotropic suspension in the organic medium.

A further aspect of this description is related to a method of forming a composition comprising exfoliated nanoplatelets functionalized with covalently bound surface-modifiers. The method comprises exfoliating a layered nanoclay with a surfactant. The method also comprises reacting the exfoliated layered nanoclay with a surface modifier comprising one or more of an epoxide, a silane, or an isocyanate.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A composition comprising exfoliated zirconium phosphate nanoplatelets functionalized with covalently bound surface-modifiers,
wherein the composition comprising the exfoliated zirconium phosphate nanoplatelets functionalized with covalently bound surface-modifiers is formed by removing a surfactant from a suspension comprising the exfoliated zirconium phosphate nanoplatelets and replacing the surfactant with a hydroxyl-reactive moiety,
wherein the covalently bound surface-modifiers are derived from one or more of cyclohexene oxide, 1,2-epoxy-3-phenoxypropane, or dodecyl/tetradecyl glycidyl ether.

2. A mixture, comprising:
a composition comprising exfoliated zirconium phosphate nanoplatelets functionalized with covalently bound surface-modifiers, the composition comprising the exfoliated zirconium phosphate nanoplatelets functionalized with covalently bound surface-modifiers being formed by removing a surfactant from a suspension comprising the exfoliated zirconium phosphate nanoplatelets and replacing the surfactant with a hydroxyl-reactive moiety,
wherein the covalently bound surface-modifiers are derived from one or more of cyclohexene oxide, 1,2-epoxy-3-phenoxypropane, or dodecyl/tetradecyl glycidyl ether, and
an organic medium comprising one or more of a polymer or a solvent,
wherein the composition is in a lyotropic suspension in the organic medium.

3. A method of forming the composition of claim 1 comprising the exfoliated zirconium phosphate nanoplatelets functionalized with the covalently bound surface-modifiers, the method comprising:
exfoliating a layered nanoclay comprising zirconium phosphate with the surfactant; and
removing the surfactant from the suspension comprising the exfoliated zirconium phosphate nanoplatelets and replacing the surfactant with the hydroxyl-reactive moiety by reacting the exfoliated zirconium phosphate nanoplatelets with the hydroxyl-reactive moiety comprising one or more of cyclohexene oxide, 1,2-epoxy-3-phenoxypropane, or dodecyl/tetradecyl glycidyl ether.

4. The composition of claim 1, wherein the surfactant is partially removed and replaced with a first hydroxyl-reactive moiety, and then a remainder of the surfactant is removed and replaced with a second hydroxyl-reactive moiety.
